(19) United States
(12) Patent Application Publication
(10) Pub. No.: US 2026/0211217 A1
(43) Pub. Date: Jul. 23, 2026

(54) OPTICAL ELEMENT AND CAMERA MODULE INCLUDING OPTICAL ELEMENT

(71) Applicant: Samsung Electro-Mechanics Co., Ltd., Suwon-si (KR)

(72) Inventors: So Mi YANG, Suwon-si (KR); Ho Bin GO, Suwon-si (KR); Byung Hyun KIM, Suwon-si (KR); Jae Hyuk HUH, Suwon-si (KR)

(73) Assignee: Samsung Electro-Mechanics Co., Ltd., Suwon-si (KR)

(21) Appl. No.: 19/281,923

(22) Filed: Jul. 28, 2025

(30) Foreign Application Priority Data
Dec. 12, 2024 (KR) 10-2024-0184998

(51) Int. Cl. G02B 13/00; G02B 5/09; G02B 27/00; G03B 17/17

(52) U.S. Cl. CPC G02B 13/0065; G02B 5/09; G02B 27/0018; G03B 17/17

(57) ABSTRACT

An optical element includes an incident surface, a first reflective surface, a second reflective surface, a third reflective surface, and an exit surface sequentially disposed from an object side of the optical element toward an image side of the optical element. A length of the incident surface in a first direction is different from a length of the exit surface in a second direction intersecting the first direction.

### CROSS-REFERENCE TO RELATED APPLICATIONS

This application claims the benefit under 35 USC 119(a) of Korean Patent Application No. 10-2024-0184998 filed on Dec. 12, 2024, in the Korean Intellectual Property Office, the entire disclosure of which is incorporated herein by reference for all purposes.

### BACKGROUND

### 1. Field

The present disclosure relates to an optical element and a camera module having the same.

### 2. Description of Background

In general, portable electronic devices include a camera module for capturing a still image or recording a moving image. For example, a camera module can be mounted in a mobile phone, laptop, a game console, or other portable electronic device.

Such portable electronic devices are generally manufactured in compact or small sizes to increase user convenience in terms of device portability. For example, a camera module mounted in a portable electronic device may include an optical path conversion member configured to enable changing or transforming a direction of an optical path. The optical path conversion member separates the optical path of an imaging lens system extending lengthwise in one direction into two or more directions, thereby enabling the thinning and miniaturization of the camera module.

However, since conventional camera modules simply change the direction of the optical path through an optical path conversion member, there is a limit to miniaturizing (making compact) the camera module.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical element includes an incident surface, a first reflective surface, a second reflective surface, a third reflective surface, and an exit surface sequentially disposed from an object side of the optical element toward an image side of the optical element, wherein a length of the incident surface in a first direction is different from a length of the exit surface in a second direction intersecting the first direction.

The first to third reflective surfaces may be not parallel to each other.

The first to third reflective surfaces may be disposed so that an optical axis of the incident surface and an optical axis of the exit surface are parallel to each other.

An area of the first reflective surface may be greater than an area of the third reflective surface.

The optical element may further include a first light-blocking member disposed on the incident surface and including a first opening; and a second light-blocking member disposed on the exit surface and including a second opening.

A size of the first opening may be greater than a size of the second opening.

Either one or both of the first opening and the second opening may include a protrusion to reduce a flare phenomenon.

An area of the first reflective surface may be greater than an area of the second reflective surface and an area of the third reflective surface.

In another general aspect, a camera module includes the optical element described above, an imaging lens system disposed on an object side of the incident surface; and an image sensor disposed on an image side of the exit surface.

In another general aspect, an optical element includes an incident surface, a first reflective surface, a second reflective surface, a third reflective surface, a fourth reflective surface, and an exit surface sequentially disposed from an object side of the optical element toward an image side of the optical element, wherein a length of the incident surface in a first direction is different from a length of the exit surface in a second direction intersecting the first direction.

A distance from the first reflective surface to the second reflective surface may be less than a distance from the second reflective surface to the third reflective surface.

A distance from the third reflective surface to the fourth reflective surface may be less than a distance from the first reflective surface to the second reflective surface.

An angle between the third reflective surface and the fourth reflective surface may be in a range of 8° to 32°.

The optical element may further include a first light-blocking member disposed on the incident surface and including a first opening; and a second light-blocking member disposed on the exit surface and including a second opening.

A size of the first opening may be greater than a size of the second opening.

In another general aspect, a camera module includes the optical element described above, an imaging lens system disposed on an object side of the incident surface; and an image sensor disposed on an image side of the exit surface.

Other features and aspects will be apparent from the following detailed description, the drawings, and the claims.

### BRIEF DESCRIPTION OF DRAWINGS

FIG. 1 is a perspective view of an optical element according to an embodiment.

FIG. 2 is a plan view of the optical element illustrated in FIG. 1.

FIG. 3 is a perspective view of another form of the optical element illustrated in FIG. 1.

FIG. 4 is a configuration diagram of a camera module including the optical element illustrated in FIG. 1.

FIG. 5 is a perspective view of an optical element according to another embodiment.

FIG. 6 is a plan view of the optical element illustrated in FIG. 5.

FIG. 7 is a perspective view of another form of the optical element illustrated in FIG. 5.

FIG. 8 is a configuration diagram of a camera module including the optical element illustrated in FIG. 5.

FIG. 9 is a perspective view of an optical element according to another embodiment.

FIGS. 10A and 10B are a plan view and a side view, respectively, of the optical element illustrated in FIG. 9.

FIG. 11 is a perspective view of another form of the optical element illustrated in FIG. 9.

FIG. 12 is a configuration diagram of a camera module including the optical element illustrated in FIG. 9.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In this specification, an object-side surface of an optical element refers to a surface that is closer to a subject to be photographed among both side surfaces (an incident side and an exit side) of the optical element, and an image-side surface of the optical element refers to a surface that is closer to an imaging plane (or an image sensor) among both side surfaces of the optical element.

In addition, in this specification, a distance between an incident surface, a reflection surface, and an exit surface is calculated along an optical axis. Additionally, in this specification, a first direction, a second direction, a third direction, and a fourth direction may refer to directions that are different relative to each other.

An optical element according to a first aspect of the present disclosure may include an incident surface, an exit surface, and a plurality of reflective surfaces. For example, the optical element according to the first aspect may include a first reflective surface, a second reflective surface, and a third reflective surface sequentially disposed along an optical path between the incident surface and the exit surface. The optical element according to the first aspect may have unique characteristics with respect to the incident surface and the exit surface. For example, in the optical element according to the first aspect, a length X1 of the incident surface in a first direction may be different from a length Y2 of the exit surface in a second direction intersecting the first direction.

In the optical element according to the first aspect, X1 and Y2 may satisfy a predetermined relationship. For example, X1 and Y2 may satisfy the conditional expression 0.6<Y2/X1 <1.0.

This conditional expression may be a condition for minimizing a size of a camera module including optical elements and ensuring a stable performance of the camera module. As an example, an optical element exceeding an upper limit value of the conditional expression may be difficult to mount in a small terminal because miniaturization and integration of the camera module may be difficult. As another example, an optical element that falls below a lower limit value of the conditional expression may reduce the amount of light converging to the image sensor, making it difficult to implement a high-resolution camera module. Additionally, a camera module that falls below the lower limit of the conditional expression may have a deterioration in a field relative illumination (RI) and a resolution around an optical axis.

An optical element according to a second aspect of the present disclosure may include an incident surface, an exit surface, and a plurality of reflective surfaces. For example, the optical element according to the second aspect may include a first reflective surface, a second reflective surface, a third reflective surface, and a fourth reflective surface sequentially disposed along an optical path between the incident surface and the exit surface. The optical element according to the second aspect may have unique characteristics with respect to the incident surface and the exit surface. For example, in the optical element according to the second aspect, a length of the incident surface in a first direction may be different from a length of the exit surface in a second direction intersecting the first direction.

An optical element according to a third aspect of the present disclosure may include an incident surface, an exit surface, and a plurality of reflective surfaces. For example, the optical element according to the third aspect may include a first reflective surface, a second reflective surface, and a third reflective surface sequentially disposed along an optical axis between the incident surface and the exit surface. The optical element according to the third aspect may have unique characteristics with respect to the incident surface and the exit surface. For example, in the optical element according to the third aspect, an area of the incident surface may be greater than an area of the exit surface.

An optical element according to a fourth aspect of the present disclosure may include an incident surface, an exit surface, and three reflective surfaces. For example, the optical element according to the fourth aspect may include a first reflective surface, a second reflective surface, and a third reflective surface sequentially disposed along an optical axis between the incident surface and the exit surface. In the optical element according to the fourth aspect, the first to third reflective surfaces may have a unique dispositional relationship relative to each other. For example, in the optical element according to the fourth aspect, the first to third reflective surfaces may be disposed so that they are not parallel to each other. In the optical element according to the fourth aspect, the incident surface and the exit surface may have a unique arrangement. For example, in the optical element according to the fourth aspect, the incident surface and the exit surface may be disposed to face an object (a subject).

An optical element according to a fifth aspect of the present disclosure may include an incident surface, an exit surface, and three reflective surfaces. For example, the optical element according to the fifth aspect may include a first reflective surface, a second reflective surface, and a third reflective surface sequentially disposed along an optical axis between the incident surface and the exit surface. In the optical element according to the fifth aspect, the incident surface and the exit surface may have a unique arrangement. For example, in the optical element according to the fifth aspect, one side of the incident surface may be connected to one side of the exit surface.

A camera module according to an aspect of the present disclosure may include an imaging lens system and an image sensor. Additionally, the camera module according to one aspect may include unique forms of optical elements. For example, the camera module according to an aspect may be configured to include any one of the optical elements according to the first to fifth aspects described above.

A camera module according to an aspect may satisfy a predetermined relationship between the imaging lens system and the optical element. For example, a distance H along an optical axis from a foremost lens of the imaging lens system to a first reflection surface of the optical element and a distance PD12 along an optical axis from the first reflection surface to a second reflection surface of the optical element may satisfy the conditional expression 0.6<PD12/H<2.5.

This conditional expression may be a condition for securing a telephoto performance and miniaturization of the camera module. As an example, a camera module exceeding an upper limit of the conditional expression may be advantageous in implementing a long focal length, but the optical element may become excessively long, making it difficult to mount the camera module in a small terminal. As another example, a camera module that falls below a lower limit value of the conditional expression may be difficult to mount in a thin terminal due to the size of the imaging lens system. As another example, a camera module that falls below the lower limit value of the conditional expression may not have a sufficient back focal length, thereby limiting an improvement of the telephoto performance of the camera module. Additionally, a camera module that falls below the lower limit value of the conditional expression may have a considerable thickness (or height), making it difficult to mount the camera module in the thin terminal, or a portion of the camera module may protrude outside the thin terminal.

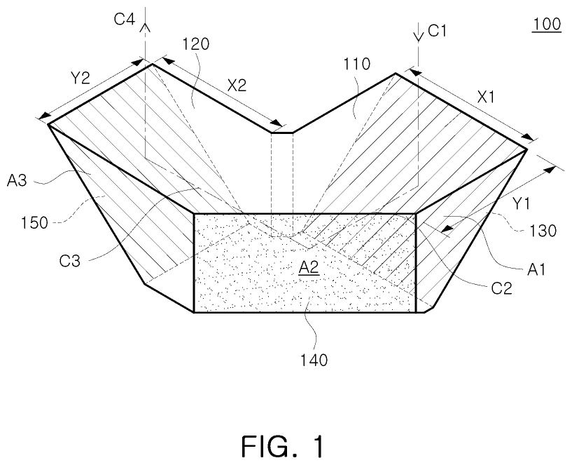

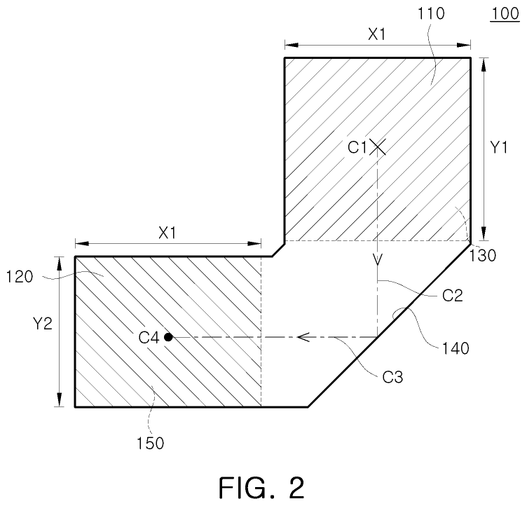

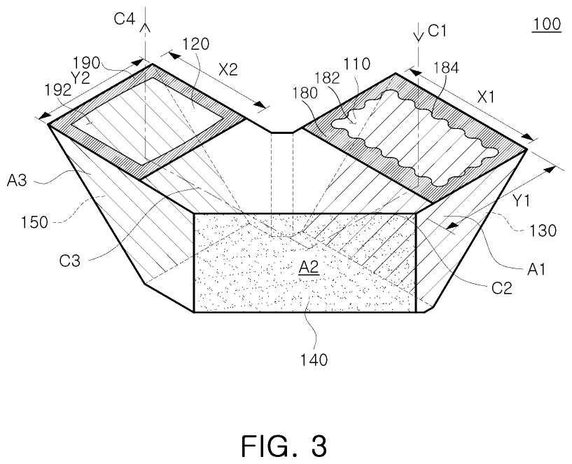

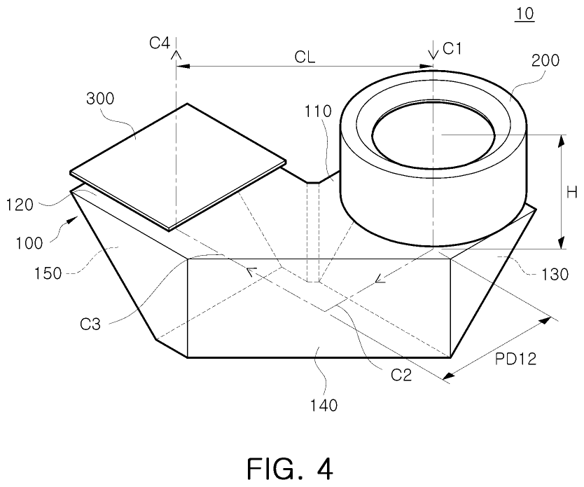

FIG. 1 is a perspective view of an optical element according to an embodiment. FIG. 2 is a plan view of the optical element illustrated in FIG. 1. FIG. 3 is a perspective view of another form of the optical element illustrated in FIG. 1. FIG. 4 is a configuration diagram of a camera module including the optical element illustrated in FIG. 1.

Referring to FIG. 1, an optical element 100 according to an embodiment may include an incident surface 110 and an exit surface 120. For example, the optical element 100 may include an incident surface 110 on which light reflected from an object is incident, and an exit surface 120 from which light incident from the incident surface 110 is emitted to an imaging plane (or an image sensor). The optical element 100 may include a plurality of reflective surfaces 130, 140, and 150. For example, the optical element 100 may include a first reflective surface 130, a second reflective surface 140, and a third reflective surface 150 sequentially disposed between the incident surface 110 and the exit surface 120.

The incident surface 110 and the exit surface 120 may have a predetermined size relationship relative to each other. As an example, a length X1 of the incident surface 110 in a first direction may be less than or equal to a length X2 of the exit surface 120 in the first direction. Additionally, the length X1 of the incident surface 110 in the first direction may be greater than a length Y2 of the exit surface 120 in a second direction intersecting the second direction. As an example, the second direction may be perpendicular to the first direction. As another example, a length Y1 of the incident surface 110 in the second direction may be greater than the length Y2 of the exit surface 120 in the second direction. Additionally, the length Y1 of the incident surface 110 in the second direction may be less than or equal to the length X2 of the exit surface 120 in the first direction.

The first reflective surface 130, the second reflective surface 140, and the third reflective surface 150 may be disposed in a unique dispositional relationship relative to each other. As an example, the first reflective surface 130, the second reflective surface 140, and the third reflective surface 150 may be disposed so that they are not parallel to each other. As a specific example, the first reflective surface 130 may be disposed so that it is not parallel to the second reflective surface 140 and the third reflective surface 150, and the second reflective surface 140 may be disposed so that it is not parallel to the third reflective surface 150. The configuration of the first reflective surface 130 to the third reflective surface 150 may be advantageous in concentrating a long optical path into a narrow space. As another example, the first reflective surface 130 to the third reflective surface 150 may be disposed so that a first optical axis C1 of the incident surface 110 and a fourth optical axis C4 of the exit surface 120 are parallel to each other or substantially parallel to each other. As a specific example, the first reflective surface 130 may be configured to reflect light incident along the first optical axis C1 in a direction of a second optical axis C2 intersecting the first optical axis C1, the second reflective surface 140 may be configured to reflect light incident along the second optical axis C2 in a direction of a third optical axis C3 intersecting the first optical axis C1 and the second optical axis C2, and the third reflective surface 150 may be configured to reflect light incident along the third optical axis C3 in a direction of the fourth optical axis C4 intersecting the second optical axis C2 and the third optical axis C3.

The first reflective surface 130 to the third reflective surface 150 may have a predetermined size relationship relative to one another. As an example, an area A1 of the first reflective surface 130 may be equal to an area A2 of the second reflective surface 140, but may be greater than an area A3 of the third reflective surface 150. The size relationship between the first reflective surface 130 to the third reflective surface 150 may be a condition for minimizing a size of the optical element 100.

The optical element 100 according to the present embodiment may be configured so that the characteristics of light incident through the incident surface 110 and the characteristics of light emitted through the exit surface 120 do not change. For example, the optical element 100 may be configured so that refractive indices and Abbe numbers of the incident surface 110, the first reflective surface 130 to the third reflective surface 150, and the exit surface 120 are the same.

The optical element 100 according to the present embodiment may be configured to control either one or both of an amount of light incident through the incident surface 110 and an amount of light emitted through the exit surface 120. For example, the optical element 100 may include a first light-blocking member 180 and a second light-blocking member 190 respectively disposed on the incident surface 110 and the exit surface 120 as illustrated in FIG. 3.

An opening may be formed in each of the first light-blocking member 180 and the second light-blocking member 190 to control the amount of incident or emitted light. For example, a first opening 182 for controlling the amount of incident light may be formed in the first light-blocking member 180, and a second opening 192 for controlling the amount of emitted light may be formed in the second light-blocking member 190. The first opening 182 and the second opening 192 may have a predetermined size relationship relative to each other. For example, a size of the first opening 182 may be greater than a size of the second opening 192.

The first light-blocking member 180 and the second light-blocking member 190 may be configured to reduce a flare phenomenon. For example, a protrusion 184 may be formed on either one or both of the first opening 182 of the first light-blocking member 180 and the second opening 192 of the second light-blocking member 190. The protrusion 184 may be formed along edges of the first opening 182 and the second opening 192, or may be formed on a portion of the first opening 182 and the second opening 192. Additionally, the protrusion 184 may be formed in different sizes depending on the positions of the first opening 182 and the second opening 192.

The optical element 100, configured as above, may be disposed in a compact camera module 10. Referring to FIG. 4, the camera module 10 including the optical element 100 according to an embodiment will be described.

The camera module 10 according to an embodiment may include the optical element 100, an imaging lens system 200, and an image sensor 300. However, the configuration of the camera module 10 is not limited to the above-described members. For example, the camera module 10 may further include a stop and a filter.

The camera module 10 may be configured to enable long-distance shooting. As an example, the camera module 10 may be configured to have an angle of view of 30° or less. As another example, the camera module 10 may be configured so that a ratio TTL/f between a total length TTL of the imaging lens system 200, which is a distance along an optical axis from an object-side surface of a foremost lens of the imaging lens system 200 to the image sensor 300, and a focal length f of the imaging lens system 200 may be 1.0 or less.

The camera module 10 may be configured to be easily mounted on a compact terminal. For example, as illustrated in FIG. 4, the optical element 100, the imaging lens system 200, and the image sensor 300 occupying a substantial volume in the camera module 10 may be disposed in a concentrated form within a predetermined space. As a specific example, in the camera module 10, the imaging lens system 200 and the image sensor 300 may be disposed substantially adjacent to each other. As another example, the optical axis C1 of the imaging lens system 200 and the optical axis C4 of the image sensor 300 in the camera module 10 may be disposed substantially adjacent to each other while being parallel to each other or substantially parallel to each other. As another example, a line segment CL connecting the optical axis C1 of the imaging lens system 200 and the optical axis C4 of the image sensor 300 in the camera module 10 may be substantially parallel to the second reflective surface 140 of the optical element 100.

The camera module 10 may satisfy a predetermined relationship between the optical element 100 and the imaging lens system 200. For example, the camera module 10 may satisfy the following conditional expression.

0.6<PD12/H<2.5

In the above conditional expression, H is a distance along an optical axis from an object-side surface of a foremost lens of the imaging lens system 200 to the first reflective surface 130, and PD12 is a distance along an optical axis from the first reflective surface 130 of the optical element 100 to the second reflective surface 140 of the optical element 100.

The camera module 10 configured as above may densely dispose the optical element 100, the imaging lens system 200, and the image sensor 300 in a small region, thereby enabling the camera module 10 to be easily mounted in a thin or compact electronic device having a narrow space for disposing internal components.

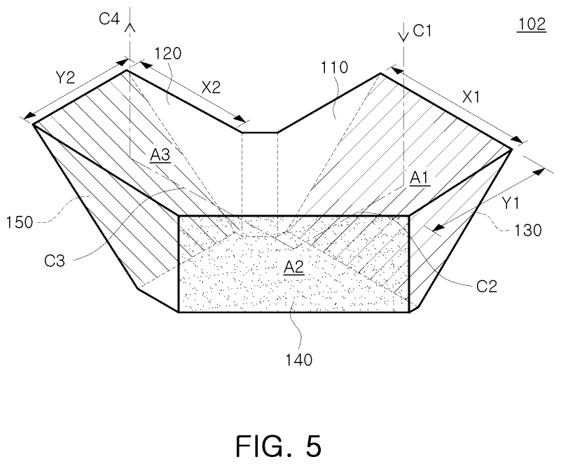

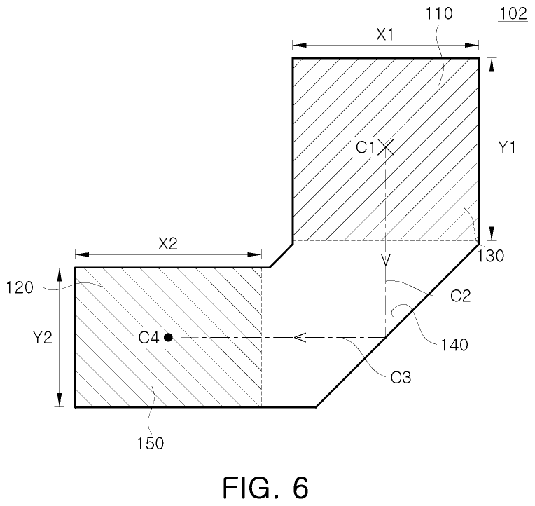

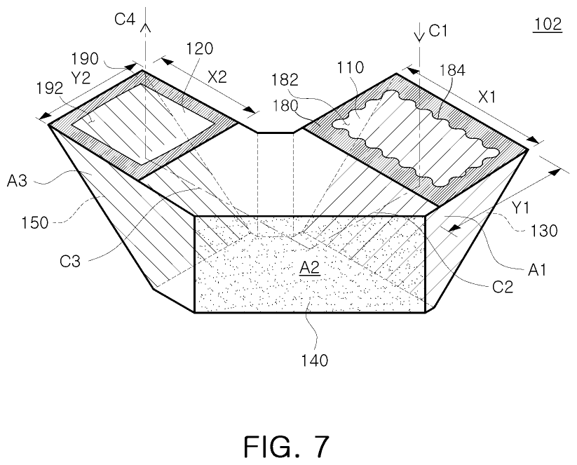

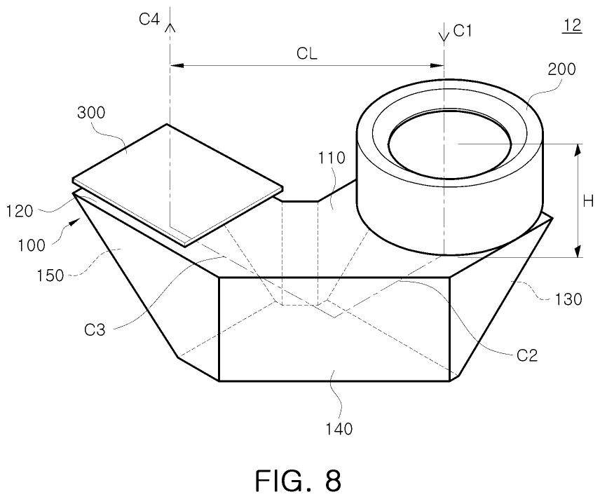

FIG. 5 is a perspective view of an optical element according to another embodiment. FIG. 6 is a plan view of the optical element illustrated in FIG. 5. FIG. 7 is a perspective view of another form of the optical element illustrated in FIG. 5. FIG. 8 is a configuration diagram of a camera module including the optical element illustrated in FIG. 5.

Referring to FIG. 5, an optical element 102 according to another embodiment may include an incident surface 110 and an exit surface 120. For example, the optical element 102 may include an incident surface 110 on which light reflected from an object is incident, and an exit surface 120 from which light incident from the incident surface 110 is emitted to an imaging plane (or an image sensor). The optical element 102 may include a plurality of reflective surfaces 130, 140, and 150. For example, the optical element 102 may include a first reflective surface 130, a second reflective surface 140, and a third reflective surface 150 sequentially disposed between the incident surface 110 and the exit surface 120.

The incident surface 110 and the exit surface 120 may have a predetermined size relationship relative to each other. As an example, a length X1 of the incident surface 110 in a first direction may be less than or equal to a length X2 of the exit surface 120 in the first direction. Additionally, the length X1 of the incident surface 110 in the first direction may be greater than a length Y2 of the exit surface 120 in a second direction intersecting the first direction. As an example, the second direction may be perpendicular to the first direction. As another example, a length Y1 of the incident surface 110 in the second direction may be greater than the length Y2 of the exit surface 120 in the second direction. Additionally, the length Y1 of the incident surface 110 in the second direction may be less than or equal to the length X2 of the exit surface 120 in the first direction.

The first reflective surface 130, the second reflective surface 140, and the third reflective surface 150 may be disposed in a unique dispositional relationship relative to each other. As an example, the first reflective surface 130, the second reflective surface 140, and the third reflective surface 150 may be disposed so that they are not parallel to each other. As a specific example, the first reflective surface 130 may be disposed so that it is not parallel to the second reflective surface 140 and the third reflective surface 150, and the second reflective surface 140 may be disposed so that it is not parallel to the third reflective surface 150. The configuration of the first reflective surface 130 to the third reflective surface 150 may be advantageous in concentrating a long optical path into a narrow space. As another example, the first reflective surface 130 to the third reflective surface 150 may be disposed so that a first optical axis C1 of the incident surface 110 and a fourth optical axis C4 of the exit surface 120 are parallel to each other or substantially parallel to each other. As a specific example, the first reflective surface 130 may be configured to reflect light incident along the first optical axis C1 in a direction along a second optical axis C2 the first optical axis C1, the second reflective surface 140 may be configured to reflect light incident along the second optical axis C2 in a direction along a third optical axis C3 intersecting the first optical axis C1 and the second optical axis C2, and the third reflective surface 150 may be configured to reflect light incident along the third optical axis C3 in a direction of the fourth optical axis C4 intersecting the second optical axis C2 and the third optical axis C1.

The first reflective surface 130 to the third reflective surface 150 may have a predetermined size relationship relative to one another. As an example, an area A1 of the first reflective surface 130 may be greater than an area A2 of the second reflective surface 140 and an area A3 of the third reflective surface 150. As another example, the area A1 of the first reflective surface 130 may be greater than the area A2 of the second reflective surface 140, and the area A2 of the second reflective surface 140 may be greater than the area A3 of the third reflective surface 150. An optical element 102 satisfying such conditions may significantly reduce a length in the second direction (the direction of the lengths Y1 and Y2). Accordingly, a camera module including the optical element 102 according to the present embodiment may be advantageous to be mounted on a compact and thin terminal.

The optical element 102 according to the present embodiment may be configured so that the characteristics of light incident through the incident surface 110 and the characteristics of light emitted through the exit surface 120 do not change. For example, the optical element 102 may be configured so that refractive indices and Abbe numbers of the incident surface 110, the first reflective surface 130 to the third reflective surface 150, and the exit surface 120 are the same.

The optical element 102 according to the present embodiment may be configured to control either one or both of an amount of light incident through the incident surface 110 and an amount of light emitted through the exit surface 120. For example, the optical element 102 may include a first light-blocking member 180 and a second light-blocking member 190 respectively formed on the incident surface 110 and the exit surface 120 as illustrated in FIG. 7.

An opening may be formed in each of the first light-blocking member 180 and the second light-blocking member 190 to control the amount of incident or emitted light. For example, a first opening 182 for controlling the amount of incident light may be formed in the first light-blocking member 180, and a second opening 192 for controlling the amount of emitted light may be formed in the second light-blocking member 190. The first opening 182 and the second opening 192 may have a predetermined size relationship relative to each other. For example, a size of the first opening 182 may be greater than a size of the second opening 192.

The first light-blocking member 180 and the second light-blocking member 190 may be configured to reduce a flare phenomenon. For example, a protrusion 184 may be formed on either one or both of the first opening 182 of the first light-blocking member 180 and the second opening 192 of the second light-blocking member 190. The protrusion 184 may be formed along edges of the first opening 182 and the second opening 192, or may be formed on a portion of the first opening 182 and the second opening 192. Additionally, the protrusion 184 may be formed in different sizes depending on the positions of the first opening 182 and the second opening 192.

The optical element 102 configured as above may be disposed in a compact camera module 12. Referring to FIG. 8, a camera module 12 including the optical element 102 according to an embodiment will be described.

The camera module 12 according to an embodiment may include the optical element 102, an imaging lens system 200, and an image sensor 300. However, the configuration of the camera module 12 is not limited to the above-described members. For example, the camera module 12 may further include a stop and a filter.

The camera module 12 may be configured to enable long-distance shooting. As an example, the camera module 12 may be configured to have an angle of view of 30° or less. As another example, the camera module 12 may be configured so that a ratio TTL/f between a total length TTL of the imaging lens system 200, which is a distance along an optical axis from an object-side surface of a foremost lens of the imaging lens system 200 to the image sensor 300, and a focal length f of the imaging lens system 200 may be 1.0 or less.

The camera module 12 may be configured to be easily mounted in a compact terminal. For example, the optical element 102, the imaging lens system 200, and the image sensor 300 occupying a substantial volume in the camera module 12 may be disposed in a concentrated form in a predetermined space as illustrated in FIG. 8. As a specific example, in the camera module 12, the imaging lens system 200 and the image sensor 300 may be disposed substantially adjacent to each other. As another example, the first optical axis C1 of the imaging lens system 200 and the fourth optical axis C4 of the image sensor 300 in the camera module 12 may be disposed substantially adjacent to each other while being parallel to each other or substantially parallel to each other. As another example, a line segment CL connecting the optical axis C1 of the imaging lens system 200 and the optical axis C4 of the image sensor 300 in the camera module 10 may be substantially parallel to the second reflective surface 140 of the optical element 102.

The camera module 12 configured as above may densely dispose the optical element 102, the imaging lens system 200, and the image sensor 300 in a small region, thereby enabling the camera module 12 to be easily mounted in a thin or compact electronic device having a narrow space for disposing internal components.

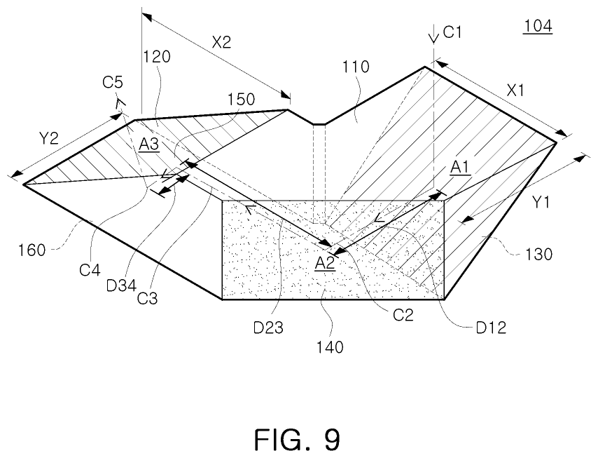

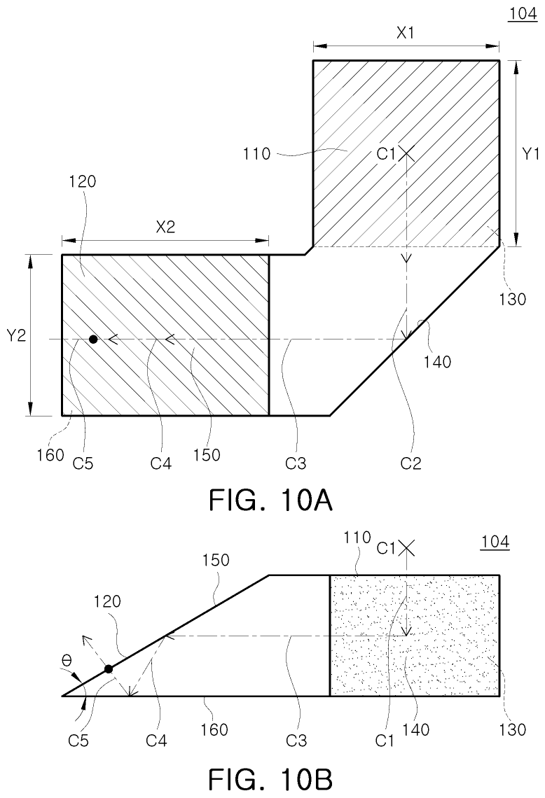

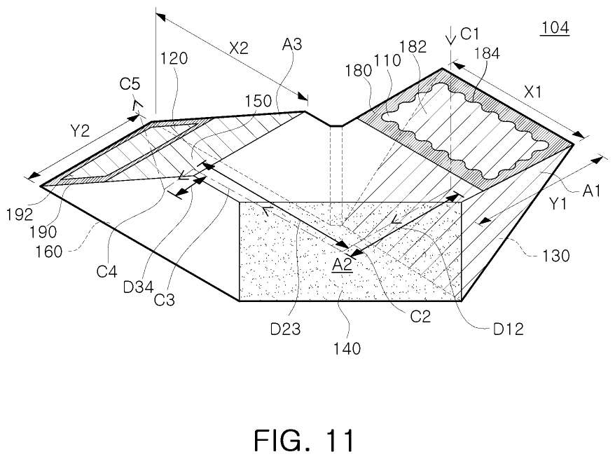

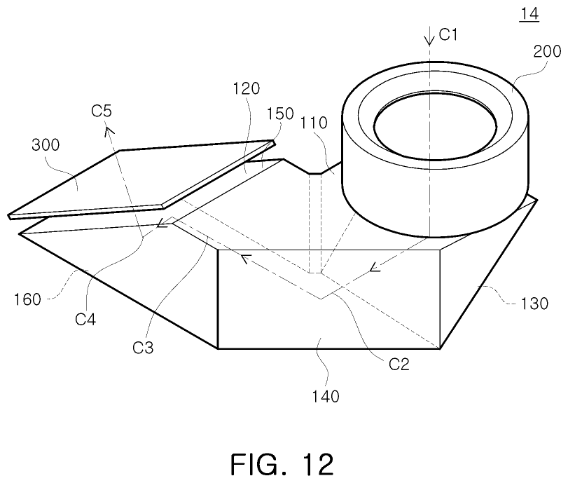

FIG. 9 is a perspective view of an optical element according to another embodiment. FIGS. 10A and 10B are a plan view and a side view, respectively, of the optical element illustrated in FIG. 9. FIG. 11 is a perspective view of another form of the optical element illustrated in FIG. 9. FIG. 12 is a configuration diagram of a camera module including the optical element illustrated in FIG. 9.

Referring to FIG. 9, an optical element 104 according to another embodiment may include an incident surface 110 and an exit surface 120. For example, the optical element 104 may include an incident surface 110 on which light reflected from an object is incident, and an exit surface 120 from which light incident from the incident surface 110 is emitted to an imaging plane (or an image sensor). The optical element 104 may include a plurality of reflective surfaces 130, 140, 150, and 160. For example, the optical element 104 may include a first reflective surface 130, a second reflective surface 140, a third reflective surface 150, and a fourth reflective surface 160 sequentially disposed between the incident surface 110 and the exit surface 120.

The incident surface 110 and the exit surface 120 may have a predetermined size relationship relative to each other. As an example, a length X1 of the incident surface 110 in a first direction may be less than a length X2 of the exit surface 120 in the first direction, but may be greater than a length Y2 of the exit surface 120 in a second direction intersecting the first direction. As an example, the second direction may be perpendicular to the first direction. As another example, a length Y1 of the incident surface 110 in the second direction may be greater than the length Y2 of the exit surface 120 in the second direction and less than the length X2 of the exit surface 120 in the first direction.

The first reflective surface 130, the second reflective surface 140, and the third reflective surface 150 may be disposed in a unique arrangement. As an example, the first reflective surface 130, the second reflective surface 140, the third reflective surface 150, and the fourth reflective member 160 may be disposed so that they are not parallel to each other. As a specific example, the first reflective surface 130 may be disposed so that it is not parallel to the second reflective surface 140 to the fourth reflective surface 160, the second reflective surface 140 may be disposed so that it is not parallel to the third reflective surface 150 and the fourth reflective surface 160, and the third reflective surface 150 may be disposed so that it is not parallel to the fourth reflective surface 160. As another example, the first reflective surface 130, the second reflective surface 140, the third reflective surface 150, and the fourth reflective surface 160 may be configured to reflect incident light in different directions relative to each other. As a specific example, the first reflective surface 130 may reflect light incident along a first optical axis C1 in a direction of a second optical axis C2 intersecting the first optical axis C1, the second reflective surface 140 may reflect light incident along the second optical axis C2 in a direction of a third optical axis C3 intersecting the second optical axis C2, the third reflective surface 150 may reflect light incident along the third optical axis C3 in a direction of a fourth optical axis C4 direction intersecting the third optical axis C3, and the fourth reflective surface 140 may reflect light incident along the fourth optical axis C4 in a direction of a fifth optical axis C5 intersecting the fourth optical axis C4. The disposition of the first reflective surface 130 to the fourth reflective surface 160 may be advantageous in concentrating a long optical path into a narrow space.

Distances between the first reflective surface 130 to the fourth reflective surface 160 may have a predetermined size relationship relative to one other. As an example, a distance D12 from the first reflective surface 130 to the second reflective surface 140 may be less than a distance D23 from the second reflective surface 140 to the third reflective surface 150. As another example, a distance D34 from the third reflective surface 150 to the fourth reflective surface 160 may be less than the distance D12 from the first reflective surface 130 to the second reflective surface 140. In an embodiment, an angle θ between the third reflective surface 150 and the fourth reflective surface 160 may be limited to a predetermined range. For example, the angle θ between the third reflective surface 150 and the fourth reflective surface 160 may be in a range of 8° to 32°. Preferably, the angle θ between the third reflective surface 150 and the fourth reflective surface 160 may be 30° or 18°.

The optical element 104 according to the present embodiment may have the exit surface 120 and one of the first reflective surface to the fourth reflective surface 160 formed to be coplanar with each other. For example, the third reflective surface 150 may be formed to be on the same plane as the exit surface 120.

The optical element 104 according to the present embodiment may be configured so that the characteristics of light incident through the incident surface 110 and the characteristics of light emitted through the exit surface 120 do not change. For example, the optical element 104 may be configured so that refractive indices and Abbe numbers of the incident surface 110, the first reflective surface 130 to the fourth reflective surface 160, and the exit surface 120 are the same.

The optical element 104 according to the present embodiment may be configured to control either one or both of an amount of light incident through the incident surface 110 and an amount of light emitted through the exit surface 120. For example, the optical element 104 may include a first light-blocking member 180 and a second light-blocking member 190 respectively formed on the incident surface 110 and the exit surface 120 as illustrated in FIG. 11.

An opening may be formed in each of the first light-blocking member 180 and the second light-blocking member 190 to control the amount of incident or emitted light. For example, a first opening 182 for controlling the amount of incident light may be formed in the first light-blocking member 180, and a second opening 192 for controlling the amount of emitted light may be formed in the second light-blocking member 190. The first opening 182 and the second opening 192 may have a predetermined size relationship relative to each other. For example, a size of the first opening 182 may be greater than a size of the second opening 192.

The first light-blocking member 180 and the second light-blocking member 190 may be configured to reduce a flare phenomenon. For example, a protrusion 184 may be formed on either one or both of the first opening 182 of the first light-blocking member 180 and the second opening 192 of the second light-blocking member 190. The protrusion 184 may be formed along edges of the first opening 182 and the second opening 192, or may be formed on a portion of the first opening 182 and the second opening 192. Additionally, the protrusion 184 may be formed in different sizes depending on the positions of the first opening 182 and the second opening 192.

The optical element 104 configured as above may be disposed in a compact camera module 14. Referring to FIG. 12, the camera module 14 including the optical element 104 according to an embodiment will be described.

The camera module 14 according to an embodiment may include the optical element 104, an imaging lens system 200, and an image sensor 300. However, the configuration of the camera module 14 is not limited to the above-described members. For example, the camera module 14 may further include a stop and a filter.

The camera module 14 may be configured to enable long-distance shooting. As an example, the camera module 14 may be configured to have an angle of view of 30° or less. As another example, the camera module 14 may be configured so that a ratio TTL/f between a total length TTL of the imaging lens system 200, which is a distance from an object-side surface of a foremost lens of the imaging lens system to the image sensor 300, and a focal length f of the imaging lens system 200 may be 1.0 or less.

The camera module 14 may be configured to be easily mounted in a compact terminal. For example, the optical element 104, the imaging lens system 200, and the image sensor 300 occupying a substantial volume in the camera module 14 may be disposed in a concentrated form in a predetermined space as illustrated in FIG. 12. As a specific example, in the camera module 14, the imaging lens system 200 and the image sensor 300 may be disposed substantially adjacent to each other.

The camera module 14 configured as above may densely dispose the optical element 104, the imaging lens system 200, and the image sensor 300 in a small region, thereby enabling the camera module 14 be easily mounted in a thin or compact electronic device having a narrow space for disposing internal components.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical element comprising:
an incident surface, a first reflective surface, a second reflective surface, a third reflective surface, and an exit surface sequentially disposed from an object side of the optical element toward an image side of the optical element,
wherein a length of the incident surface in a first direction is different from a length of the exit surface in a second direction intersecting the first direction.

2. The optical element of claim 1, wherein the first to third reflective surfaces are not parallel to each other.

3. The optical element of claim 1, wherein the first to third reflective surfaces are disposed so that an optical axis of the incident surface and an optical axis of the exit surface are parallel to each other.

4. The optical element of claim 1, wherein an area of the first reflective surface is greater than an area of the third reflective surface.

5. The optical element of claim 1, further comprising a first light-blocking member disposed on the incident surface and comprising a first opening; and
a second light-blocking member disposed on the exit surface and comprising a second opening.

6. The optical element of claim 5, wherein a size of the first opening is greater than a size of the second opening.

7. The optical element of claim 5, wherein either one or both of the first opening and the second opening comprises a protrusion to reduce a flare phenomenon.

8. The optical element of claim 1, wherein an area of the first reflective surface is greater than an area of the second reflective surface and an area of the third reflective surface.

9. A camera module comprising:
the optical element of claim 1;
an imaging lens system disposed on an object side of the incident surface; and
an image sensor disposed on an image side of the exit surface.

10. An optical element comprising:
an incident surface, a first reflective surface, a second reflective surface, a third reflective surface, a fourth reflective surface, and an exit surface sequentially disposed from an object side of the optical element toward an image side of the optical element,
wherein a length of the incident surface in a first direction is different from a length of the exit surface in a second direction intersecting the first direction.

11. The optical element of claim 10, wherein a distance from the first reflective surface to the second reflective surface is less than a distance from the second reflective surface to the third reflective surface.

12. The optical element of claim 10, wherein a distance from the third reflective surface to the fourth reflective surface is less than a distance from the first reflective surface to the second reflective surface.

13. The optical element of claim 10, wherein an angle between the third reflective surface and the fourth reflective surface is in a range of 8° to 32°.

14. The optical element of claim 10, further comprising a first light-blocking member disposed on the incident surface and comprising a first opening; and
a second light-blocking member disposed on the exit surface and comprising a second opening.

15. The optical element of claim 14, wherein a size of the first opening is greater than a size of the second opening.

16. A camera module comprising:
the optical element of claim 10;
an imaging lens system disposed on an object side of the incident surface; and
an image sensor disposed on an image side of the exit surface.
